(19) United States
(12) Patent Application Publication
(10) Pub. No.: US 2013/0295544 A1
(43) Pub. Date: Nov. 7, 2013

(54) COMPUTER-BASED MATCHING AND SOCIAL NETWORKING FOR EDUCATORS OF BLENDED LEARNING PROGRAMS

(71) Applicants: Amy Lisa Gross, Huntington Beach, CA (US); Taryn Elena Dukellis, Santa Monica, CA (US)

(72) Inventors: Amy Lisa Gross, Huntington Beach, CA (US); Taryn Elena Dukellis, Santa Monica, CA (US)

(21) Appl. No.: 13/871,536

(22) Filed: Apr. 26, 2013

Related U.S. Application Data
(60) Provisional application No. 61/638,704, filed on Apr. 26, 2012.

(51) Int. Cl. G09B 5/00

(52) U.S. Cl. CPC G09B 5/00
USPC 434/322

(57) ABSTRACT

A computer-based matching system for educators based on specific criteria related to blended instructional practices. The system promotes collaboration around blended learning initiatives and the use of digital/online resources to support instruction. Subscribers wishing to be matched with other educators may complete a questionnaire about courses that they have taught or are currently teaching. Matching criteria may include course information and the current use of digital resources and technology. The information from the questionnaire will be entered into a database. The subscriber will be able to view system-generated matches, or other educators who have implemented/are implementing the same or similar type of instructional model with the same or similar restraints, such as the number of devices (computers/tablets) available in the classroom and the current instructional delivery model. Once subscribers have been matched, they will be able to view their matches' profiles, invite matches to of their Professional Learning Community, and message matches directly through the system.

### BACKGROUND OF THE INVENTION

1. Field of the Invention

The present disclosure relates generally to social networking and, more particularly, to a computer database-based matching program that matches educators based on specific criteria related to blended classroom instruction.

2. Description of Related Art

Social networking sites are widely used today. Social networking permits users who share similar interests to connect from various remote locations and share information.

In the field of education, many educators and students have turned to computers for educational purposes. Because of the flexibility and convenience of online instructional resources, computer use for educational purposes has continued to rise. Some educators have found it useful to educate in both a brick-and-morter classroom as well as online, thus using a blended or hybrid environment for teaching. Because these blended or hybrid environments are relatively new, the educators may find it useful to network with each other to share information, e.g., devising strategies to leverage digital resources to support instruction.

There is a need for a social networking site that brings together educators who are leveraging digital resources to support instruction so that they can share information, including information on devising strategies for effective blended/hybrid learning environments and instruction.

### BRIEF SUMMARY OF DISCLOSURE

The present disclosure addresses the needs noted above by providing computer-based matching and social networking for educators exploring or practicing in blended or hybrid learning environments in accordance with one embodiment of the present disclosures a computer-based matching and social networking system is disclosed for educators of blended learning programs. The system comprises a subscriber matching module configured to match subscribers based on similar course profiles related to the instructional delivery model and use of digital resources. The system also comprises a subscriber group module configured to allow for participation in system-defined subscriber groups. The system further comprises an internal messaging module configured to receive and transmit messages between subscribers. Finally, the system comprises an advertising model configured to generate revenue.

These, as well as other objects, features and benefits will now become clear from a review of the following detailed description of illustrative embodiments and the accompanying drawings.

### BRIEF DESCRIPTION OF DRAWINGS

FIG. 1 illustrates a subscriber's home page in accordance with one embodiment of the present disclosure.

FIG. 2 illustrates a subscriber's profile in accordance with one embodiment of the present disclosure.

FIG. 3 illustrates a course page description in accordance with one embodiment of the present disclosure.

FIG. 4 illustrates a group discussion page in accordance with one embodiment of the present disclosure.

FIG. 5 illustrates a Professional Learning Community in accordance with one embodiment of the present disclosure.

### DETAILED DESCRIPTION OF THE DISCLOSURE

The computer-based matching and social network system for educators of blended learning programs may be used to match educators based on specific criteria related to blended or hybrid instruction. In the embodiments described herein, the system supports K-12 instructors and administrators as they gain experience and develop their skills in blended program design, implementation, and instruction. Although the illustrative embodiments describe a system for K-12 educators, the system may be used by educators of any other level.

The system connects individual educators with their peers to establish collaborative partnerships in order to promote individual exploration of the developing world of blended instruction. Using the present system, subscribers are matched with other subscribers who have similar course profiles. Once matched, the subscribers may connect with one another to ask and answer questions. The matched subscribers may also request feedback on ideas or plans related to blended program design, implementation, and instruction. The matched instructors may also collaborate on new initiatives.

The system promotes collaboration related to developing blended learning initiatives. As used herein, “blended” or “hybrid” instruction means instruction based on not only the traditional model where students receive information in a face-to-face environment, but it also relates to the leveraging of digital/online resources to support the delivery of instructional content. Thus, the instruction is based on a blend or hybrid of traditional and online instruction.

Educators wishing to use the computer-based matching and social networking system of the present disclosure may complete a questionnaire. The questionnaire may seek information about specific criteria involving a course or multiple courses that the educator has taught in the past, or is currently teaching. Based on the questionnaire, educators may be matched base on specific criteria related to blended or hybrid instruction.

Specific criteria gleaned from the questionnaire may include course information and the current use of digital resources and technology. The questionnaire may include, e. g., ten (10) questions related to the weighted criteria described hereinbelow at Table 1. The information from each user-created course may be entered into a database. The user may then be able to view system-generated matches. These matches may identify other educators who have implemented or are implementing the same or similar type of blended/hybrid instructional approaches with the same or similar restraints. Such restraints may include the number of devices (computers/tablets) available in the classroom and the current instructional delivery model. Once educators have been matched, they may view their matches' profiles, add matches to their Professional Learning Communities, and message matches directly through the system.

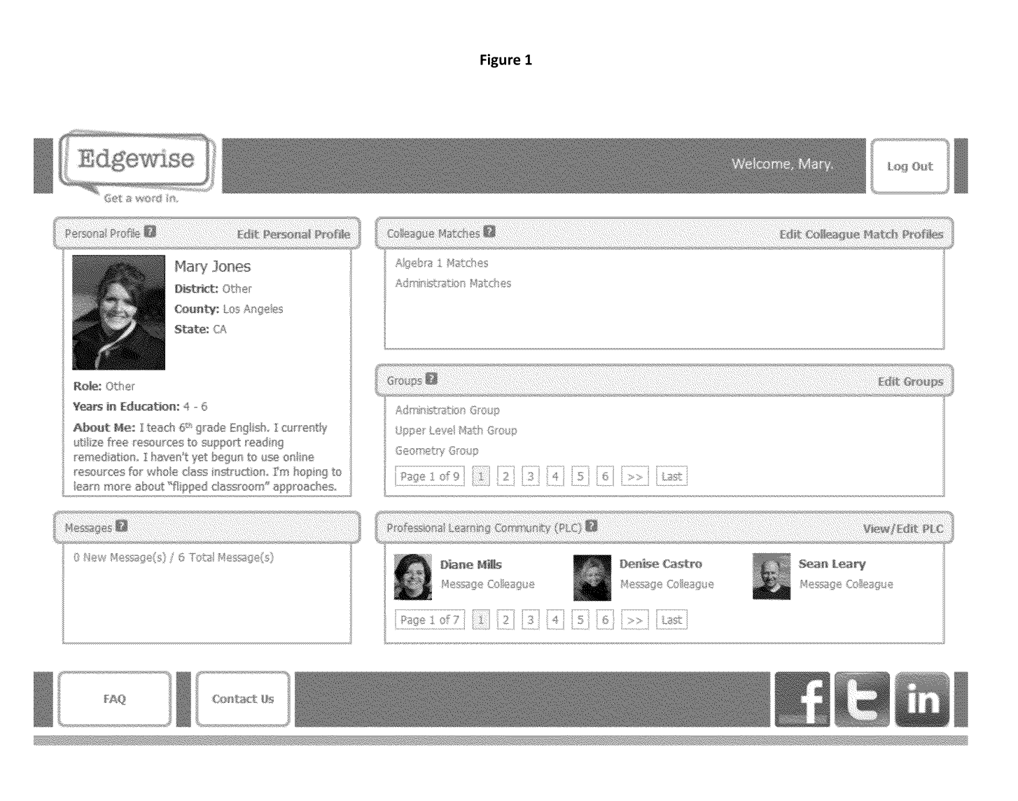

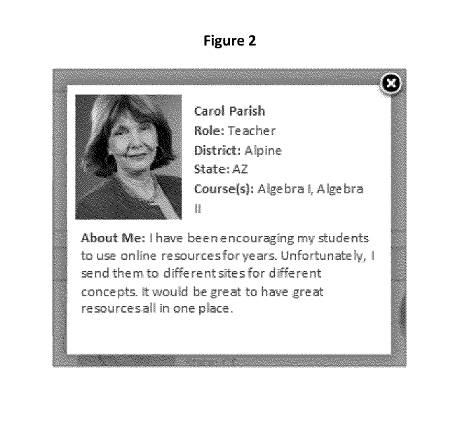

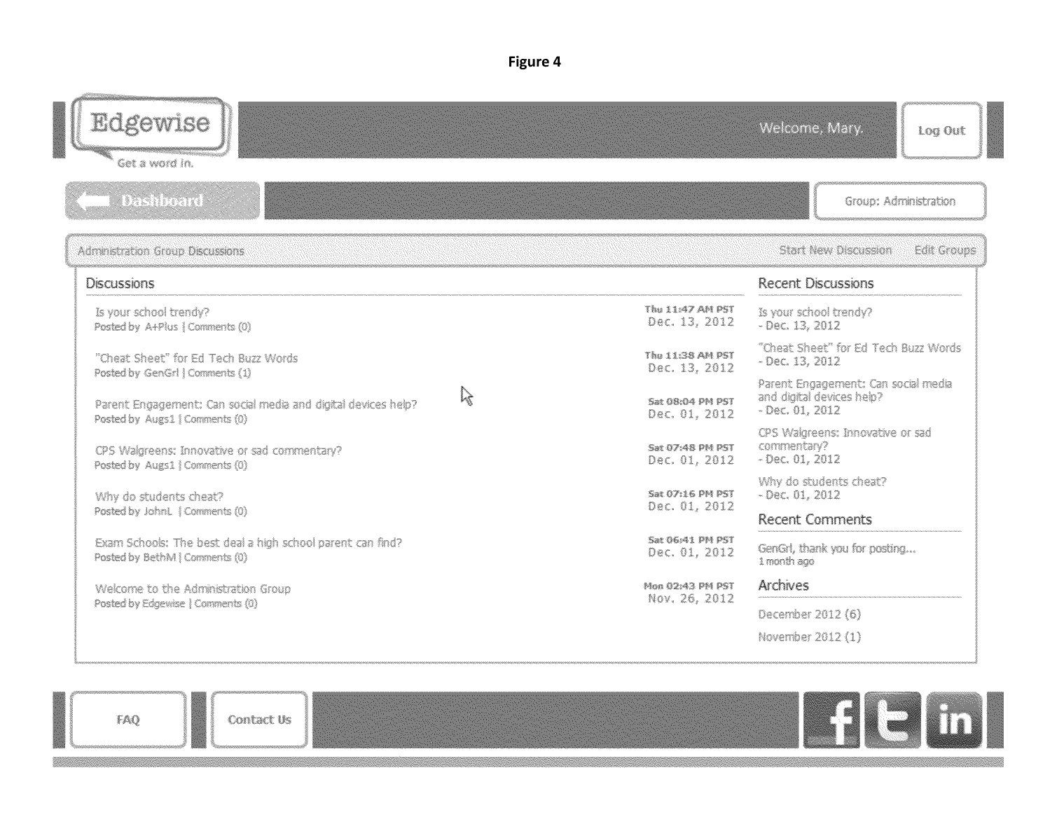

The key features of the site include profiles, system-defined user groups, internal messaging, linking capability, advertising opportunities, and colleague matching. The internal messaging feature may be seen hereinbelow in connection with FIG. 1 hereinbelow. The subscriber profile is shown in greater detail in connection with FIG. 2 hereinbelow. System-defined used groups are described in further detail in connection with FIG. 4 hereinbelow.

As for its linking capability, the site may link subscribers to other subscribers with similar profiles via matching. For example, a subscriber may be in the process of selecting an open source reading remediation program. If the subscriber has thirty (30) students and only five (5) classroom computers, the students may only be able to work with the program for a limited amount of Instructional time due to the limited computer resources. For example, each student may only be able to work with the program one hour per week. The subscriber may choose to link to one of the system-generated matches to get the system-generated match's opinion as to possible programs and rotation schedules. The site may also link peers who already know each other via a search function. Additionally, subscribers may invite their peers who are not currently subscribed via an email function.

Users may add course profiles—as indicated by course name—to his or her account. For example, a high school Algebra I teacher may choose to add the Algebra course to his/her “My Colleague Matches” box, which displays the subscriber's courses by course/focus area. This addition will help to generate a system-defined match between the Algebra I teacher and other Algebra I teachers.

Referring now to FIG. 1, illustrated is a subscriber's home page in accordance with one embodiment of the present disclosure. As shown, the subscriber's home page is a user interface that includes, to the left, a profile section that includes identifying information about the subscriber. The user interface also includes a mailbox. As shown to the right of the user interface, the subscriber's home page also includes the user's colleagues arranged by course/focus area, groups, and Professional Learning Community.

When the subscriber selects—with a computer mouse or other input device—an area in the “profile section”, a profile pop-up may appear. Referring now to FIG. 2, illustrated is a subscriber's profile in accordance with one embodiment of the present disclosure. The user's profile may include information points about the subscriber. For example, the information points may include an About Me section in which the educator can share some information about himself/herself. As part of the information points, a subscriber may indicate his/her role, the district and state in which he/she educates, and the courses he/she teaches

As shown on the left side of the screenshot illustration, the subscriber profile may also include a return to dashboard button that returns the subscriber to the subscriber's home page. This return to dashboard button may be included on each page of the web site—not just the subscriber's profile—for ease of use.

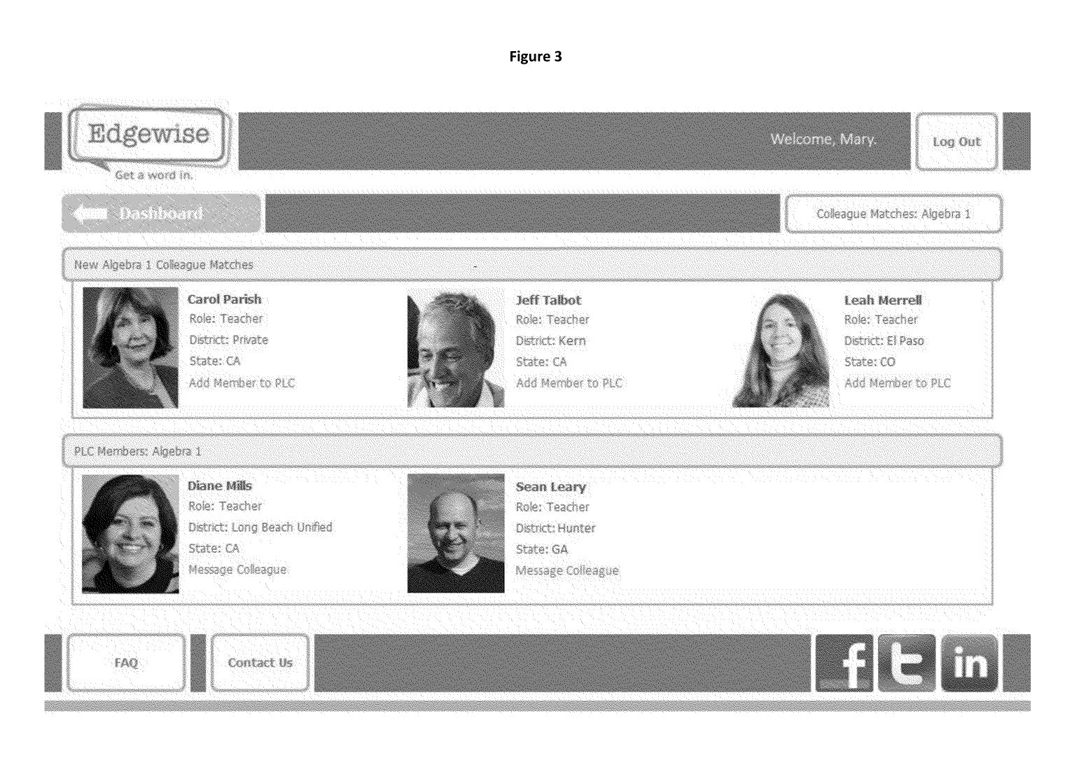

Referring now to FIG. 3, illustrated is a Colleague Matches page description in accordance with one embodiment of the present disclosure. The course page illustrated in this screenshot is for Algebra I. Members who are not part of the user's Professional Learning Community can be found in the “My Colleague Matches” box. These matches are generated by the software based on the match's selections in the course profile. Once matched, the subscriber may view profile information for a match learn more about the subscriber, invite the match to join his/her Professional Learning Community, then message the match to establish a connection.

The page permits the user to refresh the list of instructors as additional matches may be added while the user is viewing the page. The page may permit the subscriber to invite certain instructors of particular interest to the subscriber's Profession Learning Community. In this manner, the subscriber is not required to search for a particular matched instructor each time the subscriber logs on to the site. The subscriber has been matched with these instructors by the system based on weighted averages a shown in Table 1 hereinbelow.

TABLE 1

| Field | Weight |
|---|---|
| Subject/Category | 15.0 |
| Course/Focus Area | 36.0 |
| How would you describe your instructional delivery model? | 14.0 |
| How often do you currently use digital resources | 8.0 |
| (websites/apps) in your classroom? | |
| Do your students bring their own devices to class for | 4.0 |
| instructional use (BYOD)? | |
| How many devices (computers/tablets) do you have in your | 5.0 |
| classroom? | |
| How frequently can you access a class set of devices | 5.0 |
| (computers/tablets)? | |
| How many paraprofessionals are available to support | 3.0 |
| instruction? | |
| What is your average class size? | 5.0 |
| What percentage of your students has Internet access at home? | 5.0 |

Although the present implementation includes the above-referenced weighted matching, it should be understood that weighting could occur in any number of ways suitable for matching instructors exploring or practicing in hybrid or blended learning environment.

As previously illustrated in connection the other screenshots, the left side of the screenshot illustration includes the return to dashboard button that returns the subscriber to the subscribers home page.

Referring now to FIG. 4, illustrated is a group discussion page in accordance with one embodiment of the present disclosure. Shown to the right of the screenshot are discussions related to Algebra I, since the subscriber is an Algebra I teacher. Here, the high school math teacher has chosen which groups he/she would like to join. The remainder of the screenshot is similar to the prior screenshots illustrated with a return to dashboard button.

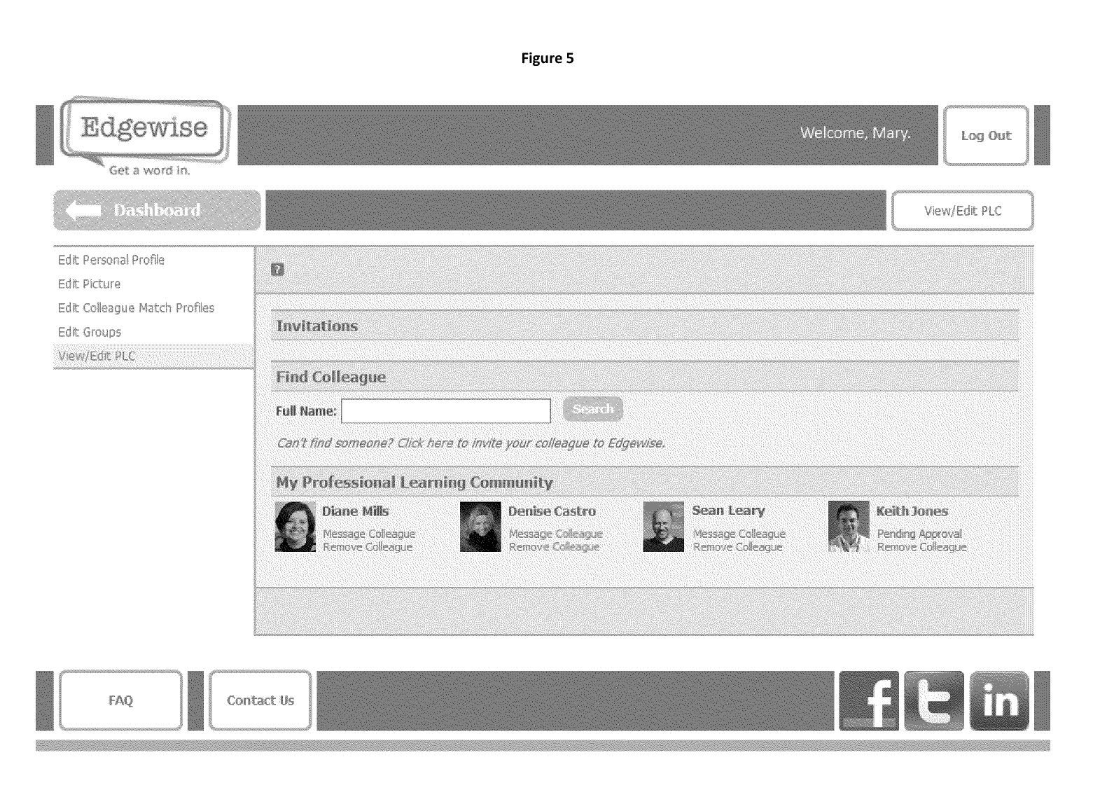

Referring now to FIG. 5, illustrated is a Professional Learning Community page in accordance with one embodiment of the present disclosure. The site includes a search box that permits subscribers to search for colleagues from their own professional networks by entering the peers name. The search box may appear on any part of the web page. Additionally, subscribers may invite their peers to become subscribers by sending an invitation email directly from the system.

While the specification describes particular embodiments of the present invention, those of ordinary skill can devise variations of the present invention without departing from the inventive concept.

We claim:

1. A computer-based matching and social networking system for educators exploring or implementing blended learning programs, comprising:
a subscriber matching module configured to match subscribers based on similar course profiles related to the instructional model and use of digital/online resources to support instruction;
a subscriber group module configured to allow for participation in system-defined subscriber groups;
an internal messaging module configured to receive and transmit messages between subscribers; and
a Professional Learning Community module configured to link subscribers.
